(19) United States
(12) Patent Application Publication
(10) Pub. No.: US 2005/0182685 A1
(43) Pub. Date: Aug. 18, 2005

(54) Shirt sales method and apparatus

(76) Inventor: Nam Hwi Kim, New Britain, PA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/030,227

(22) Filed: Jan. 6, 2005

Related U.S. Application Data
(60) Provisional application No. 60/545,044, filed on Feb. 17, 2004.

(51) Int. Cl. G06F 17/60

(52) U.S. Cl. 705/26

(57) ABSTRACT

A method to display and sell shirts at a dry cleaners. Customers can purchase shirts by viewing a shirt rack and placing an order for shirts. The shirts can be shipped to the customers directly or the customers can pick the shirts up at the dry cleaners at a later time. The dry cleaners can receive a commission for the sale.

### CROSS REFERENCE TO RELATED APPLICATIONS

This Application claims benefit and priority to Provisional Application No. 60/545,044, filed on Feb. 17, 2004, entitled, “Dress shirts displaying and selling system in dry-cleaning and laundry shop,” which is incorporated by reference herein in its entirety.

### BACKGROUND OF THE INVENTION

1. Field of the Invention

The present invention is directed to a method and apparatus to sell clothing. More particularly, the present invention is directed to a method and apparatus of selling and distributing clothing while a potential purchaser is visiting a dry-cleaning and laundry shop.

2. Description of the Related Art

Currently, when a person wishes to purchase dress shirts, he or she must either visit a retail store, purchase via catalog, or purchase online. Purchasing dress shirts can be time consuming, as a person needs to spend as much as several hours in both transportation to a store as well getting measured and choosing the desired shirt(s) and their particular characteristics. What is needed is a way that a person can purchase dress shirt(s) in a less time-consuming manner and more convenient manner.

### SUMMARY OF THE INVENTION

It is an aspect of the present invention to provide an improvement in purchasing of dress shirts and related goods.

The above aspects can be obtained by a method that includes: (a) displaying a plurality of garment models in a garment rack in a laundry shop; and (b) taking an order from a purchaser for a selected garment model of the plurality of garment models in the laundry shop.

The above aspects can also be obtained by a method that includes (a) walking into a laundry shop; (b) initiating a laundry machine; (c) while waiting for the laundry machine to finish, reviewing a garment display rack displaying a plurality of garment models; (d) selecting a garment model on the display rack to purchase; and (e) ordering the garment model at the laundry shop.

The above aspects can also be obtained by an apparatus that includes (a) a laundry shop; and (b) a garment rack displaying garments inside the laundry shop.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a diagram of an exemplary shirt rack, according to an embodiment of the present invention, according to an embodiment of the present invention;

FIG. 2 is a flowchart illustrating an exemplary method of implementing the present invention, according to an embodiment of the present invention;

FIG. 3 is a flowchart illustrating an exemplary method of processing a purchase, according to an embodiment of the present invention; and

FIG. 4 is an example of a receipt associating a laundry shop with a dress shirt sale, according to an embodiment of the present invention.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present invention relates to a method and apparatus for facilitating the sale of shirts, clothing, and other items, at a business entity such as a dry cleaners which can include any type of laundry shop such as dry cleaners, Laundromat, etc.

The present invention allows those customers an opportunity to make a purchase while they are visiting a dry-cleaners. Items such as dress shirts and other clothing can be offered for sale to the customers while they are waiting for their clothes.

The dress shirts can appear in a shirt rack in the laundry shop, for example in a highly visible area. When people are waiting for their laundry they can easily see the dress shirt rack.

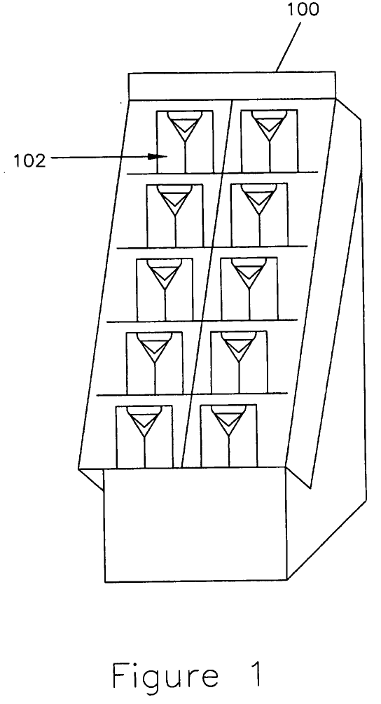

FIG. 1 is a diagram of an exemplary shirt rack, according to an embodiment of the present invention, according to an embodiment of the present invention.

A rack 100 can hold dress shirt models 102. Other merchandise besides shirts can be displayed in the rack 100 as well. Not pictured is a laundry shop in which the rack 100 and dress shirt models 102 are located inside.

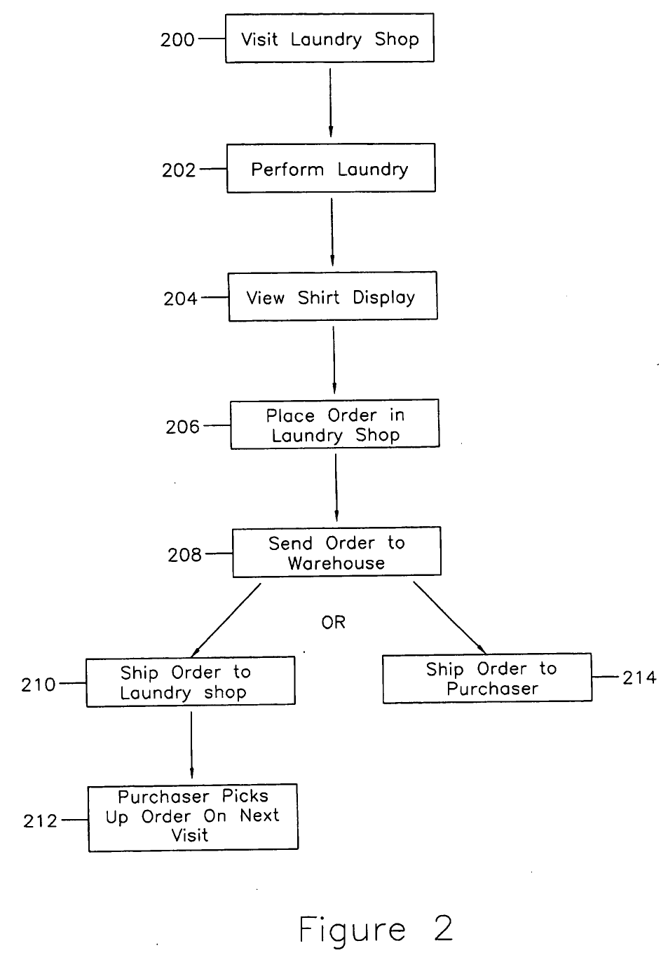

FIG. 2 is a flowchart illustrating an exemplary method of implementing the present invention, according to an embodiment of the present invention.

In operation 200, a purchaser visits a dry cleaners (which can include a Laundromat).

From operation 200, the method proceeds to operation 202, in which the purchaser performs his or her laundry. This operation can be entirely optional.

From operation 202, the method proceeds to operation 204, in which the purchaser can view the shirt model display. The shirt model display can ideally be in a location in which it is easy for the purchaser to view the shirt models (and/or other merchandise). The display can include the dress shirts, order form(s), explanation card(s), fabric patterns, neck sizes and sleeve lengths of dress shirts.

From operation 204, the method can then proceed to operation 206, in which the purchaser can then place an order for particular shirt model(s). The order can be placed in numerous manners, for example at a cashiers window at the laundry shop. An order form can be filled out, which can comprise any combination of the following: item identifications, colors, neck sizes, sleeve lengths, quantity, name of customer, date of order, and payment method. The order can also be placed at an order station (for example a kiosk) at the laundry shop. When the order is placed, the purchaser can also indicate how he or she would like to pick up the merchandise. For example, the merchandise can be shipped to the purchaser's home. Alternatively, the merchandise can be shipped to the laundry shop itself, upon which the purchaser can then pick up the merchandise.

From operation 206, the method then can proceed to operation 208, which sends the order to a warehouse. The laundry shop typically will not have the shirts ordered in stock (although they can also stock these items as well), so the laundry shop will place an order with the warehouse that stocks these items. The order can be sent to the warehouse by fax, email, via a web site, over the phone, etc.

From operation 208, the method can proceed to operation 210, which ships the order to the laundry shop, which would comprise dress shirts (or other garments) which correspond to the model(s) ordered.. This is assuming the purchaser indicated in operation 206 that he or she prefers to pick up the merchandise in person. The merchandise can be shipped in any manner, e.g. FedEx, UPS, etc.

From operation 210, the method can then proceed to operation 212, wherein the purchaser picks up his or her order from the laundry shop on his or her next visit.

From operation 208, the method can also alternatively proceed to operation 214, which ships the order directly to the purchaser. This can be performed by UPS, FEDEX, etc. This is assuming the purchaser indicated this was his or her preference upon placing the order in operation 206.

It is noted that the purchaser can pay for the purchase either in operation 206, wherein an order is placed, or in operation 212, wherein the purchaser picks the order up in person. The laundry shop can also pay the warehouse either at the time the order to the warehouse is placed, in operation 208, or at a later time, such as when the order is received from the warehouse in operation 210. The laundry shop's commission can be deducted from the laundry shop's payment to the warehouse, or alternatively the warehouse can wire (or send a check, etc.) the commission to the laundry shop.

It is noted that the system can be entirely automated, so that the taking of orders, paying of commission, and arrangements for shipping, can all be accomplished by an electronic computer at the laundry shop near the display. Thus, this just generates additional revenue for the laundry shop without any additional overhead needed.

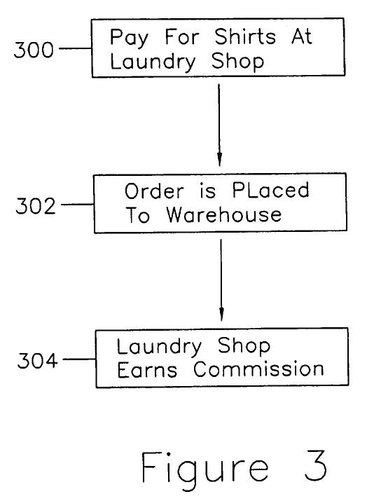

FIG. 3 is a flowchart illustrating an exemplary method of processing a purchase, according to an embodiment of the present invention.

The method begins with operation 300, wherein the purchaser pays for shirts at the laundry shop (e.g. a cashier or electronic device). The purchaser can pay by cash, check, credit card, etc.

The method then proceeds to operation 302, wherein the order is placed to a warehouse by the cashier.

The method then proceeds to operation 304, wherein the laundry shop earns a commission from the order. The laundry shop can either keep the commission upon receipt of payment in operation 300, or the warehouse can pay the cashier the commission at a later time.

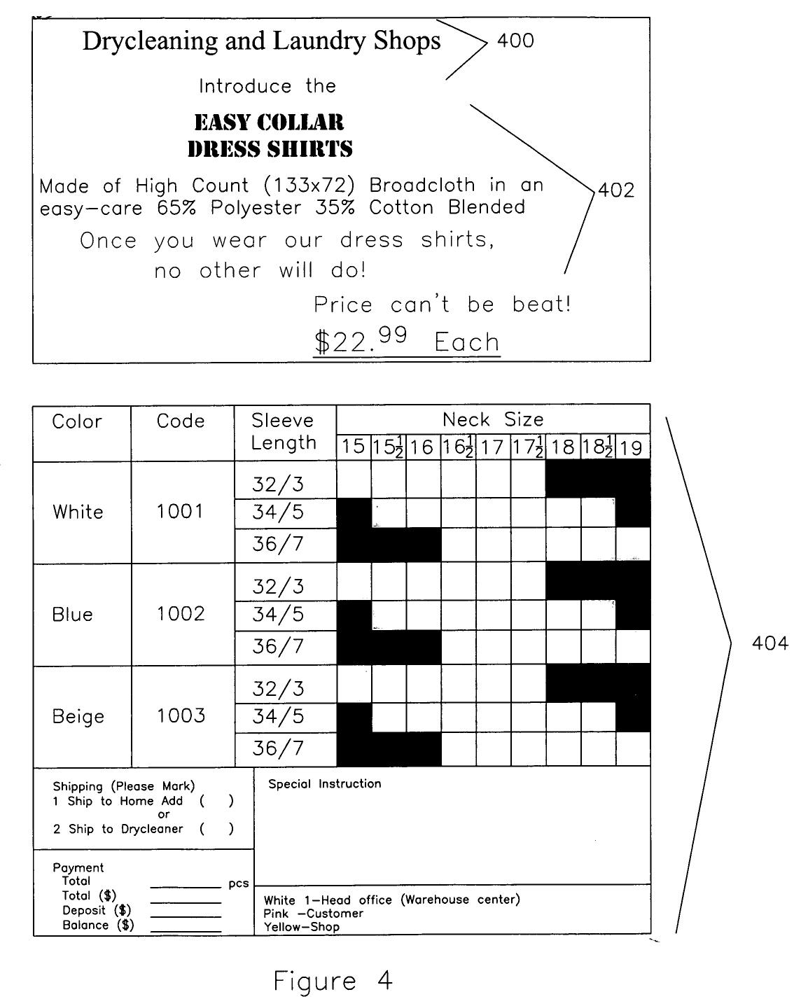

FIG. 4 is an example of a receipt associating a dry cleaners (or Laundromat) with a dress shirt sale, according to an embodiment of the present invention.

The receipt comprises a laundry shop portion 400 which contains information related to the particular laundry shop. The receipt can also comprise a dress shirt portion 402 which identifies that dress shirts are for sale which can also include a price. The receipt can also comprise a dress shirt order portion 404, which contains information on the order regarding the particular dress shirts ordered.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A method to display and sell garments, the method comprising:
displaying a plurality of garment models in a garment rack in a dry cleaners; and
taking an order from a purchaser for a selected garment model of the plurality of garment models in the dry cleaners.

2. A method as recited in claim 1, wherein the garment models are shirt models.

3. A method as recited in claim 1, wherein the garment models are clothing accessories.

4. A method as recited in claim 1, wherein the order is taken by a live cashier.

5. A method as recited in claim 1, wherein the order is taken automatically.

6. A method as recited in claim 1, wherein the laundry shop receives a commission for the order.

7. A method as recited in claim 1, wherein the dry cleaners is a Laundromat.

8. A method as recited in claim 1, wherein an ordered garment corresponding to the garment model is shipped to the purchaser.

9. A method as recited in claim 1, wherein an ordered garment corresponding to the garment model is shipped to the laundry shop to be picked up by the purchaser.

10. A method to purchase garments, the method comprising:
walking into a laundry shop;
initiating a laundry machine;
while waiting for the laundry machine to finish, reviewing a garment display rack displaying a plurality of garment models;
selecting a garment model on the display rack to purchase; and
ordering the garment model at the laundry shop.

11. A method as recited in claim 10, wherein the ordering takes place at an automated machine.

12. A method as recited in claim 10, wherein the ordering takes place at a cashier.

13. A method as recited in claim 10, further comprising:
receiving a commission, by the laundry shop, for the ordering of the garment model.

14. A method as recited in claim 10, wherein the laundry shop is a dry cleaners.

15. A method as recited in claim 10, wherein the laundry shop is a Laundromat.

16. A method as recited in claim 10, further comprising placing an order for the garment model with a warehouse by the laundry shop.

17. A method as recited in claim 16, further comprising:
shipping an ordered garment corresponding to the garment model from the warehouse to the laundry shop; and
picking up the ordered garment at the laundry shop by the purchaser.

18. A method as recited in claim 17, wherein the ordered garment is shipped directly to the purchaser from the warehouse.

19. A method as recited in claim 10, wherein the garment models are shirt models.

20. A method as recited in claim 10, wherein the garment models are clothing accessory models.

21. An apparatus, comprising:
a laundry shop; and
a garment rack displaying garments inside the laundry shop.

22. An apparatus as recited in claim 21, wherein the garments are shirt models.
